(19) United States
(12) Patent Application Publication
(10) Pub. No.: US 2023/0077853 A1
(43) Pub. Date: Mar. 16, 2023

(54) CONTROL DEVICE, METHOD, AND STORAGE MEDIUM

(71) Applicant: TOYOTA JIDOSHA KABUSHIKI KAISHA, Toyota-shi (JP)

(72) Inventor: Takumi SHIBANO, Nagoya-shi (JP)

(73) Assignee: TOYOTA JIDOSHA KABUSHIKI KAISHA, Toyota-shi (JP)

(21) Appl. No.: 17/890,404

(22) Filed: Aug. 18, 2022

(30) Foreign Application Priority Data
Sep. 6, 2021 (JP) 2021-145039

(51) Int. Cl. G06Q 50/06

(52) U.S. Cl. CPC G06Q 50/06

(57) ABSTRACT

A control device includes a control unit that acquires first information indicating an interest of a user regarding a predetermined element, acquires second information indicating a characteristic of each of a plurality of electric power plans for each item, identifies at least one of the electric power plans as a recommended electric power plan based on the interest of the user, and outputs information indicating the identified recommended electric power plan to the user. The predetermined element includes at least one of saving, environmental protection, or a region.

### CROSS-REFERENCE TO RELATED APPLICATION

This application claims priority to Japanese Patent Application No. 2021-145039 filed on Sep. 6, 2021, incorporated herein by reference in its entirety.

### BACKGROUND

### 1. Technical Field

The present disclosure relates to a control device, a method, and a storage medium.

### 2. Description of Related Art

Japanese Unexamined Patent Application Publication No. 2017-091367 (JP 2017-091367 A) discloses a technique that calculates a range of change in an electricity fee in the electricity fee plan for the consumers resulting from changes in consumer action with a predetermined algorithm based on information on a tolerance degree of action changes in consumers, and outputs information of the calculated range of change in the electricity fee to a predetermined device or an algorithm for selecting an electricity fee plan.

### SUMMARY

There is room for improvement in the method of proposing an electric power plan suitable for the user.

An object of the present disclosure is to improve the method of proposing an electric power plan suitable for a user.

A control device according to the present disclosure includes a control unit that acquires first information indicating an interest of a user regarding a predetermined element, acquires second information indicating a characteristic of each of a plurality of electric power plans for each item, and identifies at least one of the electric power plans as a recommended electric power plan based on the interest of the user and outputs information indicating the identified recommended electric power plan to the user, in which the predetermined element includes at least one of saving, environmental protection, or a region.

A method according to the present disclosure is executed by a computer and includes: acquiring first information indicating an interest of a user regarding a predetermined element; acquiring second information indicating a characteristic of each of a plurality of electric power plans for each item; and identifying at least one electric power plan among the electric power plans as a recommended electric power plan based on the interest of the user, and outputting information indicating the identified recommended electric power plan to the user, in which the predetermined element includes at least one of saving, environmental protection, or a region.

A storage medium according to the present disclosure stores a program that causes the computer to execute operations including: acquiring first information indicating an interest of a user regarding a predetermined element; acquiring second information indicating a characteristic of each of a plurality of electric power plans for each item; and identifying at least one electric power plan among the electric power plans as a recommended electric power plan based on the interest of the user, and outputting information indicating the identified recommended electric power plan to the user, in which the predetermined element includes at least one of saving, environmental protection, or a region.

According to the present disclosure, it is possible to improve the method of proposing an electric power plan suitable for a user.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a schematic configuration of a system according to an embodiment of the present disclosure; and

FIG. 2 is a diagram showing operation of the system according to the embodiment of the present disclosure.

### DETAILED DESCRIPTION OF EMBODIMENTS

Hereinafter, embodiments of the present disclosure will be described below with reference to the drawings.

In each drawing, the same or corresponding portions are denoted by the same reference signs. In the description of the present embodiment, description of the same or corresponding components will be appropriately omitted or simplified.

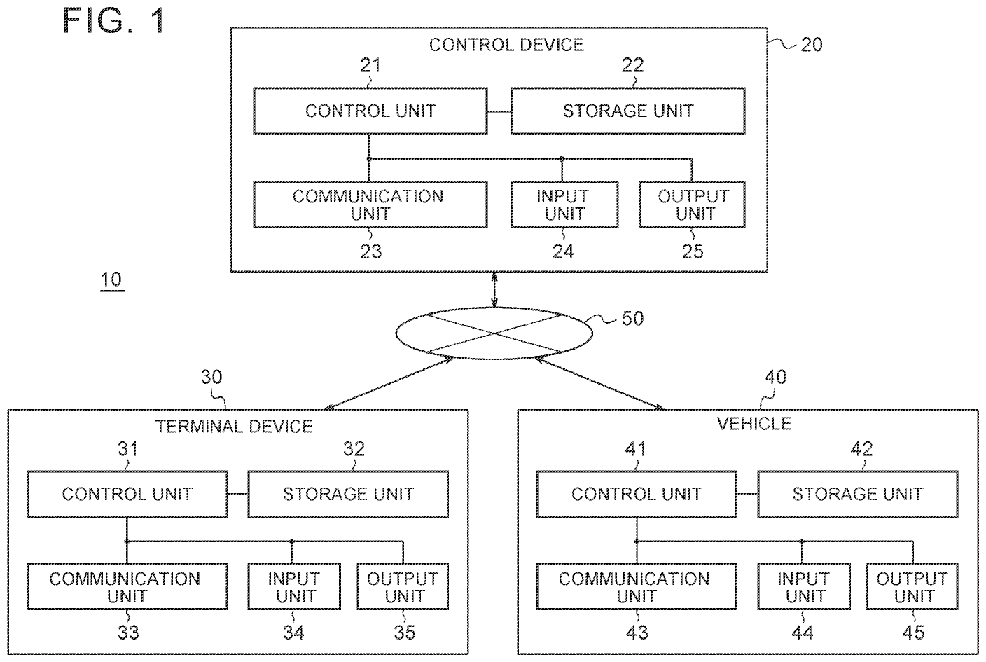

The outline of a system 10 according to an embodiment of the present disclosure will be described with reference to FIG. 1. The system 10 includes a control device 20, a terminal device 30, and a vehicle 40. The control device 20, the terminal device 30, and the vehicle 40 are communicably connected via a network 50.

The control device 20 is installed in facilities such as a data center. The control device 20 is a computer such as a server belonging to a cloud computing system or other computing systems.

The terminal device 30 is held by a user U. The terminal device 30 is, for example, a mobile device such as a mobile phone, a smartphone, a wearable device, a tablet, or a PC. The term “PC” is an abbreviation for “personal computer”.

The vehicle 40 is a vehicle of any type, such as a gasoline vehicle, a diesel vehicle, a hydrogen vehicle, an HEV, a PHEV, a BEV, or an FCEV. The term “HEV” is an abbreviation for “hybrid electric vehicle”. The term “PHEV” is an abbreviation for “plug-in hybrid electric vehicle”. The term “BEV” is an abbreviation for “battery electric vehicle”. The term “FCEV” is an abbreviation for “fuel cell electric vehicle”. The vehicle 40 is driven by the driver in the present embodiment. However, the driving may be automated at any level. The level of autonomous driving is, for example, one of levels 1 to 5 in the SAE leveling, for example. The term “SAE” is an abbreviation for the “Society of Automotive Engineers”. The vehicle 40 may be a MaaS dedicated vehicle. The term “MaaS” is an abbreviation for “mobility as a service”.

The network 50 includes the Internet, at least one WAN, at least one MAN, or any combination thereof. The term “WAN” is an abbreviation for “wide area network”. The term “MAN” is an abbreviation for “metropolitan area network”. The network 50 may include at least one wireless network, at least one optical network, or any combination thereof. The wireless network is, for example, an ad hoc network, a cellular network, a wireless LAN, a satellite communication network, or a terrestrial microwave network. The term “LAN” is an abbreviation for “local area network”.

First, the outline of the present embodiment will be described, and the details will be described later. The control device 20 acquires first information indicating the interest of the user regarding a predetermined element, acquires second information indicating a characteristic of each of a plurality of electric power plans for each item, identifies at least one of the electric power plans as a recommended electric power plan based on the interest of the user, and outputs information indicating the identified recommended electric power plan to the user. The predetermined element includes at least one of saving, environmental protection, or a region.

The predetermined element is an object of interest of the user U that influences the action of the user U regarding selecting a product or service, and includes at least one of saving, environmental protection, or a region. Not limited to this, the predetermined element may include collecting points, games, and the like. When the user U has a high degree of interest in the predetermined element, it indicates that the user U has a high preference for the element. The first information may be information indicating whether the user is interested in a predetermined element by a binary, or may be information expressing a degree of interest in a stepwise manner by a number. As described below, the first information may be generated based on the action history of the user U, or may be generated based on an input of the user U. The second information is information indicating a plurality of electric power plans and their characteristics in association with each other. The second information may be acquired from an external device by the control device 20.

According to the present embodiment, it is possible to estimate which element the user is interested in, and it is possible to select an electric power plan in which the characteristics match the interest of the user from a plurality of electric power plans, and provide the electric power plan in which the characteristics match the interest of the user. This makes it easier for the user to select the electric power plan that best suits his or her taste even when there is a plurality of electric power plans. Therefore, it is possible to improve the method of proposing an electric power plan suitable for the user.

The configuration of the control device 20 according to the present embodiment will be described with reference to FIG. 1.

The control device 20 includes a control unit 21, a storage unit 22, a communication unit 23, an input unit 24, and an output unit 25.

The control unit 21 includes at least one processor, at least one dedicated circuit, or a combination thereof. The processor is a general-purpose processor such as a CPU or a GPU, or a dedicated processor specialized for a specific process. The term “CPU” is an abbreviation for “central processing unit”. The term “GPU” is an abbreviation for “graphics processing unit”. The dedicated circuit is, for example, an FPGA or an ASIC. The term “FPGA” is an abbreviation for “field-programmable gate array”. The term “ASIC” is an abbreviation for “application specific integrated circuit”. The control unit 21 executes processes related to an operation of the control device 20 while controlling each unit of the control device 20.

The storage unit 22 includes at least one semiconductor memory, at least one magnetic memory, at least one optical memory, or a combination of at least two of them. The semiconductor memory is, for example, a RAM or a ROM. The term “RAM” is an abbreviation for “random access memory”. The term “ROM” is an abbreviation for “read only memory”. The RAM is, for example, an SRAM or a DRAM. The term “SRAM” is an abbreviation for “static random access memory”. The term “DRAM” is an abbreviation for “dynamic random access memory”. The ROM is, for example, an EEPROM. The term “EEPROM” is an abbreviation for “electrically erasable programmable read only memory”. The storage unit 22 functions as, for example, a main storage device, an auxiliary storage device, or a cache memory. The storage unit 22 stores the information used for the operation of the control device 20 and the information obtained through the operation of the control device 20. The storage unit 22 stores a system program, an application program, and the like. The storage unit 22 may store a database in which the region where the user U is living now or has lived in the past is registered in association with the name of the user U.

The communication unit 23 includes at least one communication interface. The communication interface is, for example, a LAN interface. The communication unit 23 receives information used for the operation of the control device 20, and transmits information obtained through the operation of the control device 20.

The input unit 24 includes at least one input interface. The input interface is, for example, a physical key, a capacitive key, a pointing device, a touch screen integrated with a display, or a microphone. The input unit 24 accepts an operation of inputting information used for the operation of the control device 20. The input unit 24 may be connected to the control device 20 as an external input device instead of being provided in the control device 20. As a connection method, for example, any method such as a universal serial bus (USB), a high-definition multimedia interface (HDMI) (registered trademark), or Bluetooth (registered trademark) can be used. The term “USB” is an abbreviation for “universal serial bus”. The term “HDMI (registered trademark)” is an abbreviation for “high-definition multimedia interface”.

The output unit 25 includes at least one output interface. The output interface is, for example, a display or a speaker. The display is, for example, an LCD or an organic EL display. The term “LCD” is an abbreviation for “liquid crystal display”. The term “EL” is an abbreviation for “electroluminescence”. The output unit 25 outputs information obtained by the operation of the control device 20. The output unit 25 may be connected to the control device 20 as an external output device instead of being provided in the control device 20. As a connection method, for example, any method such as a universal serial bus (USB), a high-definition multimedia interface (HDMI) (registered trademark), or Bluetooth (registered trademark) can be used.

The function of the control device 20 is realized by executing the control program according to the present embodiment with the processor corresponding to the control unit 21. That is, the function of the control device 20 is realized by software. The control program causes the computer to perform the operation of the control device 20 so that the computer functions as the control device 20. That is, the computer functions as the control device 20 by performing the operation of the control device 20 in accordance with the control program.

The program can be recorded on a non-temporary computer-readable medium (storage medium). The non-transitory computer-readable medium is, for example, a magnetic recording device, an optical disc, an opto-magnetic recording medium, or a semiconductor memory. The distribution of the program is carried out, for example, by selling, transferring, or renting a portable recording medium such as a DVD or a CD-ROM in which the program is recorded. The term “DVD” is an abbreviation for “digital versatile disc”. The term “CD-ROM” is an abbreviation for “compact disc read only memory”. The program may be stored in the storage of the server and transferred from the server to other computers to distribute the program. The program may be provided as a program product.

The computer temporarily stores the program recorded in the portable recording medium or the program transferred from the server in the main storage device, for example. The computer then causes the processor to read the program stored in the main storage device, and causes the processor to execute processes in accordance with the read program. The computer may read the program directly from the portable recording medium and execute processes in accordance with the program. The computer may execute the processes in accordance with the received program each time the program is transferred from the server to the computer. The processes may be executed by a so-called ASP service that realizes the function only by execution instruction and result acquisition without transferring the program from the server to the computer. The term “ASP” is an abbreviation for “application service provider”. The program includes information that is used for processing by electronic computers and equivalent to a program. For example, data that is not a direct command to a computer but has the property of defining the process of the computer corresponds to the “data equivalent to a program”.

A part or all of the functions of the control device 20 may be realized by a dedicated circuit corresponding to the control unit 21. That is, a part or all of the functions of the control device 20 may be realized by hardware.

The configuration of the terminal device 30 according to the present embodiment will be described with reference to FIG. 1.

The terminal device 30 includes a control unit 31, a storage unit 32, a communication unit 33, an input unit 34, and an output unit 35.

The control unit 31 includes at least one processor, at least one dedicated circuit, or a combination thereof. The processor is a general-purpose processor such as a CPU or a GPU, or a dedicated processor specialized for a specific process. The dedicated circuit is, for example, an FPGA or an ASIC. The control unit 31 performs processes related to the operation of the terminal device 30 while controlling each unit of the terminal device 30.

The storage unit 32 includes at least one semiconductor memory, at least one magnetic memory, at least one optical memory, or a combination of at least two of them. The semiconductor memory is, for example, a RAM or a ROM. The RAM is, for example, a static random access memory (SRAM) or a dynamic random access memory (DRAM). The ROM is, for example, an EEPROM. The storage unit 32 functions as, for example, a main storage device, an auxiliary storage device, or a cache memory. The storage unit 32 stores information used for the operation of the terminal device 30 and information acquired through the operation of the terminal device 30.

The communication unit 33 includes at least one communication interface. The communication interface is, for example, an interface compatible with mobile communication standards such as LTE, the 4G standard, or the 5G standard, an interface compatible with short-range wireless communication such as Bluetooth (registered trademark), or a LAN interface. The term “LTE” is an abbreviation for “long term evolution”. The term “4G” is an abbreviation for “fourth generation”. The term “5G” is an abbreviation for “fifth generation”. The communication unit 33 receives information used for the operation of the terminal device 30, and transmits information obtained through the operation of the terminal device 30.

The input unit 34 includes at least one input interface. The input interface is, for example, a physical key, a capacitive key, a pointing device, a touch screen integrated with a display, or a microphone. The input unit 34 accepts an operation of inputting information used for the operation of the terminal device 30. The input unit 34 may be connected to the terminal device 30 as an external input device instead of being provided in the terminal device 30. As a connection method, for example, any method such as a universal serial bus (USB), a high-definition multimedia interface (HDMI) (registered trademark), or Bluetooth (registered trademark) can be used.

The output unit 35 includes at least one output interface. The output interface is, for example, a display, a speaker, or a vibration motor. The display is, for example, an LCD or an organic EL display. The output unit 35 outputs the information obtained by the operation of the terminal device 30. The output unit 35 may be connected to the terminal device 30 as an external output device instead of being provided in the terminal device 30. As a connection method, for example, any method such as a universal serial bus (USB), a high-definition multimedia interface (HDMI) (registered trademark), or Bluetooth (registered trademark) can be used.

The function of the terminal device 30 is realized by executing the control program according to the present embodiment with the processor corresponding to the control unit 31. That is, the function of the terminal device 30 is realized by software. The terminal program causes the computer to perform the operation of the terminal device 30 so that the computer functions as the terminal device 30. That is, the computer functions as the terminal device 30 by performing the operation of the terminal device 30 according to the terminal program.

A part or all of the functions of the terminal device 30 may be realized by a dedicated circuit corresponding to the control unit 31. That is, a part or all of the functions of the terminal device 30 may be realized by hardware.

The configuration of the vehicle 40 according to the present embodiment will be described with reference to FIG. 1.

The vehicle 40 includes a control unit 41, a storage unit 42, a communication unit 43, an input unit 44, and an output unit 45. The vehicle 40 is further equipped with various sensors. The various sensors and the control unit 41, the storage unit 42, the communication unit 43, the input unit 44, and the output unit 45 may be communicably connected to an in-vehicle network such as a controller area network (CAN).

The control unit 41 includes one or more processors, one or more programmable circuits, one or more dedicated circuits, or a combination thereof. The processor is a general-purpose processor such as a CPU or a GPU, or a dedicated processor specialized for a specific process, for example. However, the processor is not limited to these. The programmable circuit is, for example, an FPGA, but is not limited to this. The dedicated circuit is, for example, an ASIC, but is not limited to this. The control unit 41 may include one or more electronic control units (ECUs). The control unit 41 controls the operation of the entire vehicle 40 while controlling each unit of the vehicle 40.

The storage unit 42 includes one or more memories. The memories are, for example, a semiconductor memory, a magnetic memory, or an optical memory, but are not limited to these memories. Each memory included in the storage unit 42 may function as, for example, a main storage device, an auxiliary storage device, or a cache memory. The storage unit 42 stores any information used for operation of the vehicle 40. For example, the storage unit 42 may store a system program, an application program, a database, and the like. The information stored in the storage unit 42 may be updatable with information received from the network via the communication unit 43, for example.

The communication unit 43 includes at least one communication interface. The communication interface supports, for example, a mobile communication standard such as 4G or 5G, a wired LAN standard, or a wireless LAN standard. However, the supported standards are not limited to these, and the communication interface may support any communication standard. The communication unit 43 receives information used for the operation of the vehicle 40, and sends information obtained through the operation of the vehicle 40.

The input unit 44 includes at least one input interface. The input interface is, for example, a physical key, a capacitive key, a pointing device, a touch screen integrated with a display, or a microphone. The input unit 44 accepts an operation of inputting information used for the operation of the vehicle 40. The input unit 44 may be connected to the vehicle 40 as an external input device instead of being provided in the vehicle 40. As a connection method, for example, any method such as a universal serial bus (USB), a high-definition multimedia interface (HDMI) (registered trademark), or Bluetooth (registered trademark) can be used.

The output unit 45 includes at least one output interface. The output interface is, for example, a display or a speaker. The display is, for example, an LCD or an organic EL display. The output unit 45 outputs information obtained through the operation of the vehicle 40. The output unit 45 may be connected to the vehicle 40 as an external output device instead of being provided in the vehicle 40. As a connection method, for example, any method such as a universal serial bus (USB), a high-definition multimedia interface (HDMI) (registered trademark), or Bluetooth (registered trademark) can be used.

The function of the vehicle 40 is realized by executing an arbitrary vehicle program by a processor serving as the control unit 41. That is, the function of the vehicle 40 is realized by software. The vehicle program causes the computer to execute the operation of the vehicle 40 such that the computer functions as the vehicle 40. That is, the computer functions as the vehicle 40 by executing the operation of the vehicle 40 in accordance with the vehicle program.

A part or all of the functions of the vehicle 40 may be realized by a programmable circuit or a dedicated circuit serving as the control unit 41. That is, a part or all of the functions of the vehicle 40 may be realized by hardware.

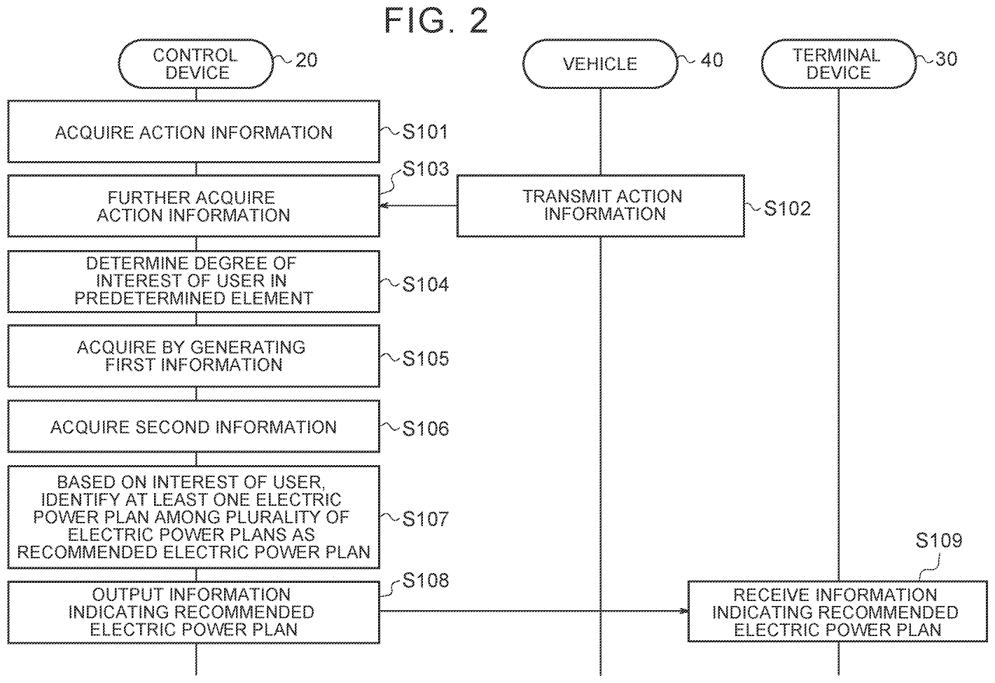

The operation of the control device 20 according to the present embodiment will be described with reference to FIG. 2. The operation of the control device 20 corresponds to a method according to the present embodiment. In the following, the control device 20 transmits and receives information to and from the terminal device 30 and the vehicle 40 via the communication unit 23.

In step S101, the control unit 21 acquires the action information indicating the action history of the user U from the external device.

The action information is information that indicates, in correspondence to the ID of the user U, a purchase history of a product or service by the user U, a usage history of a device by the user U, a movement history to an arbitrary place, and the like as the action history. The action history included in the action information is not limited to this, and may include a television viewing history, an Internet browsing history, and the like. Any method may be adopted for acquiring the action information.

In this example, it is assumed that the action history is the purchase history of the product by the user U. The control unit 21 may communicate with the terminal device of the store where the user U purchased the product, and may acquire the action information by receiving the purchase history of the product by the user U stored in the storage unit of the terminal device. Not limited to this, the purchase history may be acquired from the terminal device 30 used by the user U.

When the action information includes the usage history of the device used by the user, the control unit 21 may communicate with the device used by the user U at home or at a company, and may acquire the action history by receiving the usage history of the device by the user U, in which the action history is stored in the storage unit. The devices may include home appliances such as an air conditioner or office equipment such as a copy machine.

Not limited to the above, the action information may include various contract histories of gas, electricity, water, etc. by the user U. The control unit 21 may acquire the contract history of the user U from a server device of a gas company, an electric power company, a water company, and the like.

In step S102, the control unit 41 of the vehicle 40 transmits the action information to the control device 20.

The control unit 41 of the vehicle 40 transmits the action information of the user U in the vehicle 40 to the control device 20 at all times or in response to a request from the control device 20. In this case, the action information may include, but is not limited to, the purchase history of the user U or the usage history of the device in the vehicle 40. The usage history of the device in the vehicle 40 means the usage history of each device included in the vehicle 40. A usage status of each device may be detected by various sensors included in the vehicle 40 and may be stored in the storage unit 42 of the vehicle as the usage history by the control unit 41 of the vehicle 40.

The purchase history in the vehicle 40 means, for example, a history of charging electric power to the vehicle 40. In this case, the history of electric power charging may be stored in the storage unit 42 by the control unit 41 of the vehicle 40.

The control unit 41 of the vehicle 40 may transmit the movement history of the vehicle detected by a positioning unit to the control device 20 as the action information.

In step S103, the control unit 21 of the control device 20 further acquires the action information by receiving the action information from the vehicle 40.

In step S104, the control unit 21 of the control device 20 determines the degree of interest in the predetermined element of the user U from the acquired action information. Any method may be adopted to determine the degree of interest.

The control unit 21 determines the user U's interest in saving, environmental protection, or a region from the purchase history acquired from a terminal device of a store. When the purchase history indicates that the number of times a product whose price has been reduced from a list price has been purchased within a predetermined period is equal to or greater than a predetermined value, the control unit 21 may determine that the user U has a high degree of interest in saving, and when the purchase history indicates that the number or times the product whose price has been reduced from the list price has been purchased is less than the predetermined value, the control unit 21 may be determine that the user U has a low degree of interest in saving.

When the purchase history indicates that the number of times a product having a predetermined mark indicating that the product conforms to the standard for environmental protection is purchased within a predetermined period is equal to or more than a predetermined value, the control unit 21 determines that the user U has a high degree of interest in environmental protection, and when the purchase history indicates that the number of times a product having a predetermined mark indicating that the product conforms to the standard for environmental protection is purchased within a predetermined period is less than the predetermined value, the control unit 21 may determine that the user U has a low degree of interest in environmental protection. The predetermined mark indicating that the product conforms to the standard for environmental protection may be arbitrarily set.

When the purchase history indicates that the number of times a product whose production region is a specific region has been purchased within a predetermined period is equal to or greater than a predetermined value, the control unit 21 may determine that the user U has a high degree of interest in the region, and when the purchase history indicates that the number of times a product whose production region is a specific region has been purchased within a predetermined period is less than the predetermined value, the control unit 21 may be determine that the user U has a low degree of interest in the region. The specific region may include, for example, a region where the user U currently lives, a region where the user U has lived in the past, and the like. The control unit 21 may acquire information indicating the region where the user U has lived in the past or the region where the user U is currently living from the database stored in the storage unit 22, and may set the region as the specific region. Not limited to this, the specific region may be set freely. Products whose origin is in a particular region include various foods or goods produced or processed within that region. Goods may include clothing, miscellaneous goods, cosmetics, furniture, electronic devices, wood, paper products, and the like. Not limited to this, when the purchase history indicates that the number of times the user U has stayed at a hotel and the like of the specific region within a predetermined period is equal to or greater than a predetermined value, the control unit 21 may determine that the user U has a high degree of interest in the region, and when the number of times the user U has stayed at the hotel and the like of the specific region within the predetermined period is less than the predetermined value, the control unit 21 may be determine that the user U has a low degree of interest in the region.

The control unit 21 may determine the degree of interest of the user U in each element of saving, environmental protection, or a region from information such as a browsing history of the Internet, the application used, and the like on the terminal device 30.

When the usage history of the device by the user U acquired from the device indicates that a ratio of the time during which the device is used in an energy saving mode among an operating time of the device is equal to or more than a predetermined value, the control unit 21 may determine that the user U has a high degree of interest in saving or environmental protection, and when the usage history of the device by the user U acquired from the device indicates that the ratio of the time during which the device is used in the energy saving mode among the operating time of the device is less than the predetermined value, the control unit 21 may determine that the user U has a low degree of interest in saving electricity or environmental protection. For example, when the usage history of the air conditioner as a device by the user U indicates that a ratio in which the air conditioner is used at a set temperature in which a difference with the outside temperature is less than a predetermined value within a predetermined period is equal to or more than a predetermined value, the control unit 21 may determine that the user U has a high degree of interest in saving or environmental protection, and when the usage history of the air conditioner as the device by the user U indicates that the ratio in which the air conditioner is used when the difference with the outside temperature is less than the predetermined value within the predetermined period, the control unit 21 may determine that the user U has a low degree of interest in saving electricity or environmental protection.

When the contract history of the gas, electricity, water, etc. of the user U acquired from the server device of the business operator indicates that the fee for each predetermined period is less than a predetermined value, the control unit 21 may determine that the user U has a high degree of interest in saving, and when the contract history of the gas, electricity, water, etc. of the user U acquired from the server device of the business operator indicates that the charge for each predetermined period is equal to or more than the predetermined value, the control unit 21 may determine that the user U has a low degree of interest in saving.

When the history of charging the vehicle 40 acquired from the vehicle 40 indicates that the price per unit electric power amount at the time of charging is less than a predetermined value, the control unit 21 may determine that the user U has a high degree of interest in saving, and when the history of charging the vehicle 40 acquired from the vehicle 40 indicates that the price per unit electric energy at the time of charging is equal to or more than the predetermined value, the control unit 21 may determine that the user U has a low degree of interest in saving electricity.

When the usage history of each device that is provided in the vehicle 40 and that is acquired from the vehicle 40 indicates that a usage time of each device within a predetermined period is less than a predetermined value, the control unit 21 may determine that the user U has a high degree of interest in saving or environmental protection, and when the usage history of each device that is provided in the vehicle 40 and that is acquired from the vehicle 40 indicates that the usage time of each device within the predetermined period is less than the predetermined value is less than the predetermined value within the predetermined period, the control unit 21 may determine that the user U has a low degree of interest in saving electricity or environmental protection. For example, when the usage history of the air conditioner provided in the vehicle 40 indicates that the ratio in which the air conditioner is used at a set temperature in which the difference with the outside temperature is less than the predetermined value within the predetermined period is equal to or more than the predetermined value, the control unit 21 may determine that the user U has a high degree of interest in saving or environmental protection, and when the usage history of the air conditioner provided in the vehicle 40 indicates that the ratio in which the air conditioner is used at the set temperature in which the difference with the outside temperature is less than the predetermined value within the predetermined period is less than the predetermined value in the predetermined period, the control unit 21 may determine that the user U has a low degree of interest in saving electricity or environmental protection. For example, when the movement history of the vehicle 40 acquired from the vehicle 40 indicates that the time during which the vehicle 40 is moving in the specific region in the predetermined period is equal to or longer than the predetermined value, the control unit 41 determines that the user U has a high degree of interest in the region, and when the movement history indicates that the time during which the vehicle 40 is moving in the specific region in the predetermined period is less than the predetermined value, the control unit 41 determines that the user U has a low degree of interest in the region.

The action information acquired from the vehicle 40 may include a history of a driving operation of the vehicle 40. In this case, when the history of the driving operation indicates that the ratio of a usage frequency of an idling stop function when the vehicle 40 is stopped is equal to or higher than a predetermined value, the control unit 21 may determine that the user U has a high degree of interest in saving or environmental protection, and when the history of the driving operation indicates that the ratio of the usage frequency of the idling stop function is less than the predetermined value, the control unit 21 may determine that the user U has a low degree of interest in saving electricity or environmental protection.

In step S105, the control unit 21 acquires the first information by generating the first information based on the result of the determination based on the action history. The control unit 21 may generate the first information based on only one of the action histories, or may generate the first information based on all of the action histories. The control unit 21 may generate the first information by scoring the interest of the user U for each element. In this example, the control unit 21 adds 1 point to all the action histories when it is determined that the user U has a high degree of interest in each element, and adds 0 points when it is determined that the user U as a low degree of interest in each element. The result is generated as the first information.

In this example, it is assumed that the control unit 21 acquires the purchase history of the product as the action history from the terminal device of the store and the usage history of the device in the vehicle 40 from the vehicle 40. It is assumed that the control unit 21 determines from the purchase history that the user U has a high degree of interest in environmental protection and the region, and determines from the usage history of the device that the user U has a high degree of interest in environmental protection. In this case, an example of the first information generated by the control unit 21 is shown below.

TABLE 1

| Saving Money | Environmental Protection | Region |
|---|---|---|
| 0 | 2 | 1 |

As shown in the above table, since it is determined that the user U is interested in environmental protection from both the purchase history and the usage history serving as the action history, two points are given to the environmental protection element. Further, since it is determined from the purchase history that the user U is interested in the region, one point is given to the element of the region. In this example, the first information is shown in a table format. However, the format of the first information is not limited to this.

Not limited to the above, the control unit 21 may generate the first information based on the result of the user U answering the degree of interest in a predetermined element. Specifically, the user U inputs, into the terminal device 30, the degree of interest in each of saving, environmental protection, or region serving as the predetermined elements. The predetermined elements may be preset or may be freely input by the user U. The control unit 21 may receive the input information from the terminal device 30, score the degree of interest, and generate the information as the first information in association with the user ID of the user U.

In step S106, the control unit 21 acquires the second information indicating the characteristic of each of the plurality of electric power plans for each item. Any method may be adopted for acquiring the second information. For example, the control unit 21 communicates with the server device of at least one electric power company, and receives information indicating at least one electric power plan provided by the electric power company. The electric power company may be an electric power company capable of supplying electric power to a residential region of the user U. The control unit 21 may acquire the second information by generating the second information based on the received information. Not limited to this, the control unit 21 may acquire the second information by receiving the second information from an external device.

An example of the second information generated by the control unit 21 is shown below.

TABLE 2

| | | | Ratio of Electric |
|---|---|---|---|
| | | Emission | Power Generated |
| | Fee | Factor | in Region |
| Electric Power Plan A | X | A | 40% |
| Electric Power Plan B | Y | B | 10% |
| Electric Power Plan C | Z | C | 20% |

As shown in the table above, the second information includes information about a plurality of electric power plans. In the above table, for each of the electric power plans A to C, a “fee” occurring in a predetermined period, an “emission factor” indicating a carbon dioxide emission amount per unit electric power amount, and a “ratio of electric power produced in a region” among the calculated electric power are shown as characteristics of the electric power plan. In this example, the region is assumed to be the region where the user lives. The control unit 21 may generate the second information by calculating the fee per unit electric power amount, the emission factor, and the ratio of the electric power produced in the region from the information indicating the electric power plan acquired from the electric power company. This makes it possible to generate the second information that allows equal comparison of the plurality of electric power plans provided by the plurality of electric power companies. The items indicating the characteristics of the electric power plan are not limited to this, and may include, for example, information indicating an evaluation by the user, a point rate of an affiliated company given in accordance with a usage amount, and the like. The control unit 21 stores the acquired second information in the storage unit 22.

In step S107, based on the interests of the user U, the control unit 21 identifies at least one of the electric power plans as the recommended electric power plan.

Any method may be adopted to identify the recommended electric power plan. In this example, the control unit 21 scores the characteristics of the electric power plan indicated by the second information for each item. Specifically, the control unit 21 first assigns a reference score to each item and converts each item into a score. As for the standard score, the lower the fee or the emission factor, the higher the given score, and the higher the ratio of the electric power produced in the region, the higher the given score. The conditions for giving a reference score may be set arbitrarily. For example, a threshold value may be set and a predetermined score may be given when the value of each item is equal to or higher than the threshold value. In this example, in the second information, an example in which the control unit 21 scores each item is shown below.

TABLE 3

| | | | Ratio of Electric |
|---|---|---|---|
| | | Emission | Power Generated |
| | Fee | Factor | in Region |
| Electric Power Plan A | 3 | 1 | 4 |
| Electric Power Plan B | 2 | 2 | 1 |
| Electric Power Plan C | 1 | 3 | 2 |

Next, the control unit 21 determines the correspondence between the element related to the interest of the user indicated by the first information and the item of the electric power plan. In this example, the elements indicated by the first information are “saving”, “environmental protection”, and “region”. The control unit 21 associates these elements with the items of a “fee occurring in a predetermined period”, an “emission factor”, and a “ratio of electric power calculated in the region”, respectively. The correspondence is not limited to this, and a plurality of elements and a single item may be associated with each other, or a single element and a plurality of items may be associated with each other. For example, when the item of the electric power plan further includes a “ratio of electric power derived from natural energy”, that two items that are the item thereof and the item of the “emission factor” may be associated with the element of “environmental protection”. Electric power derived from natural energy means electric power produced by hydroelectric power generation, wind power generation, solar power generation, etc.

Next, the control unit 21 calculates a score for each item of the electric power plan associated with each predetermined element. In the calculation, the control unit 21 weights the points for each item according to the associated elements. The conditions for weighting the points may be set arbitrarily. For example, the higher the degree of interest that the user U has regarding a predetermined element among the elements indicated by the first information, the higher the control unit 21 may set a weight on the associated item and perform scoring. In this case, for the same user U, the higher the degree of interest that the user U has regarding a predetermined element in comparison to other elements, the higher the control unit 21 may set a weight for the item corresponding to the element and perform scoring. The higher the degree of interest in the predetermined element of the target user U in comparison with the other users, the higher the control unit 21 may set the weight for the item of the element and perform scoring. In this way, the control associates the predetermined element with the item among the items, and the higher the degree of interest that the user U has regarding the predetermined element, the higher the control unit sets the weight for the item, and the control unit performs scoring.

Not limited to this, for example, when the electric power in the region is surplus, the control unit 21 may set a high weight to “the ratio of the electric power produced in the region” that is the item corresponding to the “region” and perform scoring.

In this example, it is assumed that the target user U has a high degree of interest in the element of “environmental protection” in comparison to the other users. The control unit 21 sets a value of 3 for the item of the “emission factor” corresponding to the element of “environmental protection”, sets a value of 1 as the weight for the item of the “fee” that corresponds to the element of “saving” and for the item of the “ratio of electric power calculated in the region” that corresponds to the element of the “region”, and calculates the weight by multiplying the reference score in Table 3. The control unit 21 adds up the calculated values of each item. Table 4 below shows the results of the control unit 21 that scored each item of each electric power plan indicated by the second information.

TABLE 4

| | | | Ratio of Electric | |
|---|---|---|---|---|
| | | Emission | Power Generated | |
| | Fee | Factor | in Region | Total |
| Electric Power Plan A | 3 | 3 | 4 | 10 |
| Electric Power Plan B | 2 | 6 | 1 | 9 |
| Electric Power Plan C | 1 | 9 | 2 | 12 |

From Table 4, the electric power plan with the highest total value is Plan C. The control unit 21 identifies the electric power plan C having the highest total value as the recommended electric power plan. The number of recommended electric power plans identified by the control unit 21 is not limited to one. For example, the control unit 21 may identify all plans in which the calculated total value is equal to or greater than a predetermined value as the recommended electric power plan.

In step S108, the control unit 21 outputs information indicating the identified recommended electric power plan.

Any method may be adopted for outputting the information indicating the recommended electric power plan, and the control unit 21 may output the information by directly displaying the information on the output unit 25 of the control device 20. In this example, the control unit 21 outputs information indicating the electric power plan C serving as the recommended electric power plan, by transmitting the information to the terminal device 30 of the user U.

The information indicating the recommended electric power plan may include arbitrary information such as information indicating the characteristics of the recommended electric power plan for each item, discount information of the electric power company providing the recommended electric power plan, and the like. The control unit 21 may also output information indicating a fee that occurs for a predetermined electric power consumption amount when the recommended electric power plan is used. The predetermined electric power consumption amount may be freely set, and may be, for example, the electric power consumption amount of the user U last year. When the user U switches from the electric power plan that is currently used to the identified recommended electric power plan, the control unit 21 may calculate how much the fee occurred for a predetermined power consumption amount changes, and may output information indicating the calculated result by including the information indicating the calculated result in the information indicating the recommended electric power plan.

In step S109, the terminal device 30 receives information indicating the recommended electric power plan. The control unit 31 of the terminal device 30 causes the output unit 35 to display the information. This allows the user U to see information about the proposed recommended electric power plan. After that, the operation of the system 10 ends.

As described above, the control device 20 according to the present embodiment includes the control unit 21. The control unit 21 acquires first information indicating the interest of the user regarding a predetermined element, acquires second information indicating a characteristic of each of a plurality of electric power plans for each item, identifies at least one of the electric power plans as a recommended electric power plan based on the interest of the user, and outputs information indicating the identified recommended electric power plan to the user. The predetermined element includes at least one of saving, environmental protection, or a region.

According to the present embodiment, it is possible to estimate which element the user is interested in to what degree, and it is possible to provide an electric power plan that matches the user from a plurality of electric power plans, based on the estimation result. When the characteristics of the electric power plan match the elements that the user is interested in, the electric power plan is proposed, which makes it easier for the user to select the electric power plan that best suits his or her taste. Therefore, it is possible to improve the method of proposing an electric power plan suitable for the user.

As described above, in the control device 20 according to the present embodiment, the control unit 21 acquires the action information indicating the user's action history, and generates the first information based on the acquired action information. The action information includes the purchase history as the action history.

According to this embodiment, it is possible to estimate which element the user is interested in from the action of the user. Since the interest of the user is estimated from the actions unconsciously taken by the user, it becomes easier to propose an electric power plan that is more suitable for the user. Therefore, it is possible to improve the method of proposing an electric power plan suitable for the user.

As described above, the control device 20 according to the present embodiment further includes the communication unit 23 that communicates with the vehicle 40 on which the user has boarded. The control unit 21 acquires the action information from the vehicle 40 via the communication unit 23.

According to the present embodiment, the action information of the user can be acquired from the vehicle 40 on which the user has boarded, and the interest of the user can be estimated accurately based on more action information. As a result of the estimation, an electric power plan suitable for the user is provided. Thus, the user can easily select the proposed power plan. Therefore, it is possible to improve the method of proposing an electric power plan suitable for the user.

As described above, in the control device 20 according to the present embodiment, the item includes at least one of the fee occurring in the predetermined period, the emission factor indicating the carbon dioxide emission amount per unit electric power amount, and the ratio of electric power calculated in the region. The control unit 21 scores the characteristics of the electric power plan for each item and adds up the score, and identifies the electric power plan having the largest total value as the recommended electric power plan.

According to this embodiment, it is possible to more accurately evaluate and compare the characteristics of the electric power plans, regarding the items common to many electric power plans. As a result of the evaluation, an electric power plan suitable for the user is provided. Thus, the user can easily select the proposed power plan. Therefore, it is possible to improve the method of proposing an electric power plan suitable for the user.

As described above, in the control device 20 according to the present embodiment, the control unit 21 associates a predetermined element with an item, and the higher the interest of the user in the predetermined element, the higher the control unit 21 sets the weight for the associated item, and the control unit 21 performs scoring.

According to this embodiment, the electric power plan that suits the interest of the user is more highly evaluated and proposed to the user. For example, referring to Table 1, the user has a low degree of interest in “saving” and a high degree of interest in “environmental protection”. Further, referring to Tables 2 and 3, the electric power plan C finally identified by the control unit 21 has the highest “fee” but the lowest “emission factor”. Thus, it can be said that the electric power plan C is the electric power plan most suitable for the interest of the user, and when the electric power plan is proposed to the user, the user can easily select the electric power plan and make a contract. Therefore, it is possible to improve the method of proposing an electric power plan suitable for the user.

As described above, in the control device 20 according to the present embodiment, the control unit 21 outputs information indicating a fee occurred for a predetermined power consumption when the recommended electric power plan is used.

According to this embodiment, the user can confirm the cost occurred for the proposed electric power plan. Since the user is provided with a determination material when selecting an electric power plan, it becomes easier for the user to select the proposed power plan. Therefore, the method of proposing the electric power plan can be improved.

As a modification of the present disclosure, the control unit 21 may acquire a learning model that outputs the recommended electric power plan when the first information and the second information are input, and may output to the user, information indicating the recommended electric power plan output by the learning model.

Any method may be adopted for acquiring the learning model. For example, the control unit 21 uses, as learning data, a data set in which the first information and the second information are associated with the electric power plan finally selected by the user among the second information, so as to generate a learning model by using an arbitrary machine learning method. In this way, the control unit 21 may acquire the learning model that has learned a relationship between the first information and the second information and the electric power plan finally selected by the user among the second information. In this case, the control unit 21 inputs the acquired first information and the second information to the learning model, and outputs to the user, the information indicating the recommended electric power plan output by the learning model.

According to this modification, the learning model more accurately selects the recommended electric power plan that suits the user. Therefore, it is possible to improve the method of proposing an electric power plan suitable for the user.

The present disclosure is not limited to the embodiment described above. For example, blocks shown in the block diagram may be integrated, or a block may be divided. Instead of executing the steps shown in the flowcharts in chronological order according to the description, the steps may be executed in parallel or in a different order, depending on the processing capacities of the devices that execute the steps, or as necessary. Other changes may be made without departing from the scope of the present disclosure.

What is claimed is:

1. A control device comprising a control unit that acquires first information indicating an interest of a user regarding a predetermined element,
acquires second information indicating a characteristic of each of a plurality of electric power plans for each item, and
identifies at least one of the electric power plans as a recommended electric power plan based on the interest of the user and outputs information indicating the identified recommended electric power plan to the user,
wherein the predetermined element includes at least one of saving, environmental protection, or a region.

2. The control device according to claim 1,
wherein the control unit acquires action information indicating an action history of the user, and generates the first information based on the acquired action information, and
wherein the action information includes a purchase history as the action history.

3. The control device according to claim 2,
further comprising a communication unit that communicates with a vehicle on which the user has boarded,
wherein the control unit acquires the action information from the vehicle via the communication unit.

4. The control device according to claim 1,
wherein the item includes at least one of a fee occurring in a predetermined period, an emission factor indicating a carbon dioxide emission amount per unit electric power amount, and a ratio of electric power calculated in the region, and
wherein the control unit scores the characteristic of the electric power plan for each item and adds up a score, and identifies an electric power plan having a largest total value as the recommended electric power plan.

5. The control device according to claim 4, wherein the control unit associates the predetermined element with the item, sets a higher weight for the item associated with the predetermined element having a higher interest of the user, and performs scoring.

6. The control device according to claim 1, wherein the control unit outputs information indicating a fee that occurs for a predetermined electric power consumption amount when the recommended electric power plan is used.

7. The control device according to claim 1, wherein the control unit acquires a learning model that outputs the recommended electric power plan when the first information and the second information are input, and the control unit outputs to the user, information indicating the recommended electric power plan output by the learning model.

8. A method that is executed by a computer, the method comprising:
acquiring first information indicating an interest of a user regarding a predetermined element;
acquiring second information indicating a characteristic of each of a plurality of electric power plans for each item; and
identifying at least one electric power plan among the electric power plans as a recommended electric power plan based on the interest of the user, and outputting information indicating the identified recommended electric power plan to the user,
wherein the predetermined element includes at least one of saving, environmental protection, or a region.

9. The method according to claim 8,
further comprising acquiring action information indicating an action history of the user, and generating the first information based on the acquired action information,
wherein the action information includes a purchase history as the action history.

10. The method according to claim 9,
wherein the computer further includes a communication unit that communicates with a vehicle on which the user has boarded, and
wherein the method further includes acquiring the action information from the vehicle via the communication unit.

11. The method according to claim 8,
wherein the item includes at least one of a fee occurring in a predetermined period, an emission factor indicating a carbon dioxide emission amount per unit electric power amount, and a ratio of electric power calculated in the region, and
wherein the method further includes scoring the characteristic of the electric power plan for each item and adding up the score, and identifying an electric power plan having a largest total value as the recommended electric power plan.

12. The method according to claim 11, further comprising associating the predetermined element with the item, setting a higher weight for the item associated with the predetermined element having a higher interest of the user, and performing scoring.

13. The method according to claim 8, further comprising outputting information indicating a fee that occurs for a predetermined electric power consumption amount when the at least one identified electric power plan is used.

14. The method according to claim 8, further comprising acquiring a learning model that outputs the recommended electric power plan when the first information and the second information are input, and outputting to the user, information indicating the recommended electric power plan output by the learning model.

15. A non-transitory storage medium that stores a program that causes a computer to execute operations including:
acquiring first information indicating an interest of a user regarding a predetermined element;
acquiring second information indicating a characteristic of each of a plurality of electric power plans for each item; and
identifying at least one electric power plan among the electric power plans as a recommended electric power plan based on the interest of the user, and outputting information indicating the identified recommended electric power plan to the user,
wherein the predetermined element includes at least one of saving, environmental protection, or a region.

16. The storage medium according to claim 15 that causes the computer to execute the operations further comprising acquiring action information indicating an action history of the user, and generating the first information based on the acquired action information,
wherein the action information includes a purchase history as the action history.

17. The storage medium according to claim 16,
wherein the computer further includes a communication unit that communicates with a vehicle on which the user has boarded, and
wherein the program causes the computer to execute the operations further including acquiring the action information from the vehicle via the communication unit.

18. The storage medium according to claim 15,
wherein the item includes at least one of a fee occurring in a predetermined period, an emission factor indicating a carbon dioxide emission amount per unit electric power amount, and a ratio of electric power calculated in the region, and
wherein the program causes the computer to execute the operations further including scoring the characteristic of the electric power plan for the item and adding up the score, and identifying an electric power plan having a largest total value as the recommended electric power plan.

19. The storage medium according to claim 18, wherein the program causes the computer to execute the operations further including associating the predetermined element with the item, setting a higher weight for the item associated with the predetermined element having a higher interest of the user, and performing scoring.

20. The storage medium according to claim 15, wherein the program causes the computer to execute the operations further comprising outputting information indicating a fee that occurs for a predetermined electric power consumption amount when the at least one identified electric power plan is used.
